(19) United States
(12) Patent Application Publication
(10) Pub. No.: US 2013/0057121 A1
(43) Pub. Date: Mar. 7, 2013

(54) ELECTRICAL ROTATING MACHINE

(71) Applicants: Mitsuaki Izumi, Hitachinaka (JP); Yosuke Umesaki, Hitachinaka (JP); Toshio Ishikawa, Hitachinaka (JP)

(72) Inventors: Mitsuaki Izumi, Hitachinaka (JP); Yosuke Umesaki, Hitachinaka (JP); Toshio Ishikawa, Hitachinaka (JP)

(73) Assignee: HITACHI AUTOMOTIVE SYSTEMS, LTD., Hitachinaka-shi, Ibaraki (JP)

(21) Appl. No.: 13/697,422

(22) PCT Filed: May 17, 2011
(86) PCT No.: PCT/JP2011/061281

§ 371 Date: Nov. 12, 2012

(30) Foreign Application Priority Data
May 26, 2010 (JP) 2010-120420

(51) Int. Cl. H02K 5/22; H02K 11/04

(52) U.S. Cl. 310/68 D; 310/89

(57) ABSTRACT

An electrical rotating machine which includes: a rotor; a stator provided with an armature winding, the rotor and the stator being housed in a housing space formed by a front bracket and a rear bracket; and a rear cover provided with a circumferential side wall and a bottom wall and disposed near the bottom of the rear bracket. The rear cover includes a plurality of engaging openings formed in the circumferential side wall of the rear cover, and steps of the engaging openings each produced by the difference between the diameter of the side wall on the bottom wall side and the diameter of the side wall on the end opening side. The bracket has engaging portions inserted into the corresponding steps for fixing the rear bracket.

### TECHNICAL FIELD

The present invention relates to an electrical rotating machine provided with a rear cover.

### BACKGROUND ART

The trend in designing electrical rotating machines in recent years is toward compactness and high output. The compact and high-output electrical rotating machines, as a necessary consequence of compactness and high output, generate a greater amount of heat and cause high temperature, and therefore require efficient cooling for the machines. For improving cooling efficiency, a typical type of electrical rotating machine employs such an arrangement which disposes a rectification circuit, an IC regulator, slip rings, brushes and other heating components on the bottom of a rear bracket.

These heating components, which correspond to high-voltage components, are protected by a rear cover attached thereto for prevention of contact between the heating components and the outside. The rear cover provided for this purpose has a bottomed cylindrical shape containing an inside housing space, that is, a bowl shape.

According to this structure, fixation between the rear cover and an electrical rotating machine is essential. Examples of this fixing method include a fastening method which uses bolts as disclosed in PTL 1, and a fixing technology which uses engaging claws provided with hooks and formed on the rear cover side wall.

### CITATION LIST

### Patent Literature

PTL 1: JP-A-2002-95215

### SUMMARY OF INVENTION

### Technical Problem

According to PTL 1, a clearance in the axial direction is required for engagement between the engaging claws of the rear cover and the rear bracket. This clearance causes interference between the rear cover and the rear bracket, and generates interference noise (noise).

Particularly, in the case of an electrical rotating machine mounted on a vehicle such as an automobile, the electrical rotating machine subjected to great vibrations generated in multiple directions needs to be equipped with a rear cover more refined through improvement of the fixing method.

### Solution to Problem

An electrical rotating machine according to the invention includes: a rotor; a stator provided with an armature winding, the rotor and the stator being housed in a housing space formed by a front bracket and a rear bracket; and a rear cover provided with a circumferential side wall and a bottom wall and disposed near the bottom of the rear bracket. The rear cover includes a plurality of engaging openings formed in the circumferential side wall of the rear cover, and steps of the engaging openings each produced by the difference between the diameter of the side wall on the bottom wall side and the diameter of the side wall on the end opening side. The bracket has engaging portions inserted into the corresponding steps for fixing the rear bracket.

### Advantageous Effects of Invention

According to the invention, a rear cover can be fixed to an electrical rotating machine with high rigidity in a simple fashion, and with high resistance to vibrations.

### BRIEF DESCRIPTION OF DRAWINGS

FIG. 1 illustrates a rear cover according to an embodiment as viewed in the axial direction.

FIG. 2 is a vertical cross-sectional view of an alternating current generator for vehicle.

FIG. 3 is a vertical cross-sectional view of a part of the alternating current generator for vehicle.

FIG. 4 illustrates a condition of the alternating current generator for vehicle to which a vehicle side current supply harness is attached.

FIG. 5 is a cross-sectional view of the rear cover.

FIG. 6 is a side view of the rear cover.

FIG. 7 is a front view of a mold terminal.

FIG. 8 is a cross-sectional view of a mold terminal engaging claw.

FIG. 9 illustrates a condition of attachment of the rear cover.

FIG. 10 is a side view of the rear cover in the attached condition.

FIG. 11 illustrates the rear cover to which the vehicle side current supply harness is attached.

### DESCRIPTION OF EMBODIMENTS

An embodiment is hereinafter described with reference to the drawings.

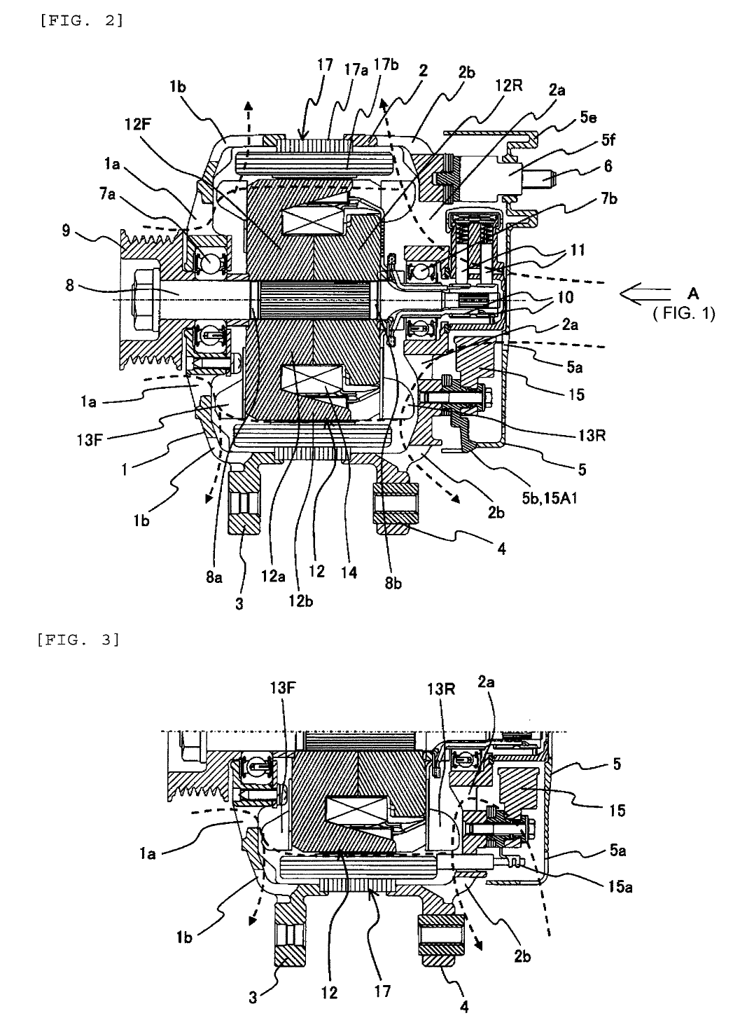

FIG. 2 illustrates an example of an alternating current generator for vehicle as an electrical rotating machine to which this embodiment is applicable. This figure is a vertical cross-sectional view of the alternating current generator for vehicle. Discussed herein is the structure of a typical electrical rotating machine to which this embodiment is applicable. This description clarifies the arrangement of a rectification circuit, an IC regulator, slip rings, brushes and others disposed on the bottom of a rear bracket.

As illustrated in FIG. 2, each of a front bracket 1 and a rear bracket 2 has a bottomed cylindrical shape containing an inside housing space, that is, a bowl shape. Moreover, the front bracket 1 and the rear bracket 2 have fixing portions 3 and 4, respectively, provided with openings as fixing holes. The fixing portions 3 and 4 are formed integrally with the front bracket 1 and the rear bracket 2 and projected in the radial direction toward the outer circumferential side. The fixing portions 3 and 4 are fixed to a vehicle via bolts (not shown). Each of the front bracket 1 and the rear bracket 2 is made of aluminum alloy and formed by a forming method such as die casting.

A rear cover 5 having a smaller thickness than that of each bracket is attached to the axial end of the rear bracket 2. The rear cover 5 has a bottomed cylindrical shape containing an inside housing space, that is, a bowl shape similarly to the respective brackets. The invention pertains to improvement of the method for fixing the rear cover 5 to the electrical rotating machine. Prior to description for this improvement, the structure of the electrical rotating machine is herein discussed as an introduction. The rear cover 5 has a plurality of air inlet ports 5a on the inside circumference and the outside circumference of the rear cover 5 as openings through which air flows. Moreover, an output terminal 6 connected with a battery is attached to the outside circumference of the rear cover 5. The rear cover 5 is made of resin or aluminum alloy.

Ball bearings 7a and 7b functioning as bearings are attached approximately to the centers in the radial direction of the axial outer ends of the front bracket 1 and the rear bracket 2, respectively. The ball bearing 7a attached to the front bracket 1 has a larger diameter than that of the ball bearing 7b attached to the rear bracket 2.

A shaft 8 is inserted through the inner rings of the ball bearings 7a and 7b. The shaft 8 is supported in such a manner as to be freely rotatable relative to the front bracket 1 and the rear bracket 2.

A pulley 9 as a rotation transmitting member is fixed to the end of the shaft 8 near the front bracket 1 in such a manner as to rotate in combination with the rotation of the shaft 8 by connection therewith via bolts. Revolutions of a not-shown engine are transmitted to a crank pulley, and then transmitted to the pulley 9 via a belt. Thus, the shaft 8 rotates in proportion to pulley ratios of the pulley 9 and the crank pulley to the revolution numbers of the engine.

A pair of slip rings 10 are attached to the end of the shaft 8 near the rear bracket 2 in such a manner as to rotate in combination with the rotation of the shaft 8. According to this structure, electric power is supplied to the slip rings 10 via a pair of brushes 11 sliding in contact with the respective slip rings 10. Thus, the slip rings 10 are positioned on the bottom of the rear bracket 2.

A front rotor member 12F and a rear rotor member 12R each made of magnetic material are provided substantially at the center of the shaft 8 in the rotation axis direction in such a manner as to rotate in combination with the rotation of the shaft 8. The front rotor member 12F and the rear rotor member 12R are individually connected with the shaft 8 by serration junction. The outside ends of the front and rear rotor members 12F and 12R are plastically flowed in annular grooves 8a and 8b formed in the shaft 8 such that the rotor members 12F and 12R are regulated in the axial direction in such a condition as to face to each other in contact with each other. The front rotor member 12F and the rear rotor member 12 R fixed to the shaft 8 in this manner constitute a rotor 12.

Plate-shaped fans 13F and 13R each of which has a plurality of impellers on the outer circumferential side are provided on one and the other end surfaces of the rotor 12 in the rotation axis direction, respectively. The fans 13F and 13R rotate in combination with the rotation of the rotor 12.

Each of the front rotor member 12F and the rear rotor member 12R has a shaft portion 12a positioned on the inner circumferential side, and a plurality of rotor magnet claw poles 12b positioned on the outer circumferential side and each having an L-shaped cross section in the radial direction. The axial ends of the shaft portions 12a of the rotor members 12F and 12R face to each other in contact therebetween to constitute a Lundell-type iron core. A field winding 14 is wound around the rotation axis in the space between the outside circumferences of the shaft portions 12a and the inside circumferences of the rotor magnet claw poles 12b. Both ends of the field winding 14 are extended along the shaft 8 and connected with the slip rings 10 discussed above.

The components designated by a reference number 11 are brushes which supply field current via the slip rings 10 discussed above. Thus, the brushes 11 are also positioned on the bottom of the rear bracket 2.

Current supplied to the field winding 14 is controlled in accordance with the condition of the battery of the vehicle in such a manner that power generation starts when the power generation voltage becomes higher than the battery voltage of the vehicle. An IC regulator (not shown) functioning as a voltage control circuit for adjustment of the power generation voltage is contained in a rectification circuit 15 (described below) disposed inside the rear cover 5, so as to control the terminal voltage of the output terminal 6 such that the terminal voltage becomes a constant voltage.

A stator 17 is sandwiched between the front bracket 1 and the rear bracket 2 and fixed thereto. The stator 17 in the fixed condition is located in such a position that the inside circumference of the stator 17 faces to the outside circumferences of the rotor magnet claw poles 12b of the rotor 12 with a small clearance left between the stator 17 and the rotor magnet claw poles 12b. The stator 17 is constituted by a stator iron core 17a made of magnetic material, and an armature winding 17b wound along the stator iron core 17a. The armature winding 17b is connected with the rectification circuit 15 attached to the inside of the rear cover 5. The rectification circuit 15 is further connected with the battery via the output terminal 6.

The rectification circuit 15 includes a plurality of diodes. There are provided six diodes constituting independent three-phase coils for allowing full wave rectification. The rectification circuit 15 is also positioned on the outside of the bottom of the rear bracket 2. The IC regulator (not shown) is contained in the rectification circuit 15 provided within the rear cover 5. Thus, the IC regulator is similarly disposed on the outside of the bottom of the rear bracket 2. Accordingly, the module of the rectifier constituted by the IC regulator and the rectification circuit 15 is disposed on the outside of the bottom of the rear bracket 2. This position corresponds to the inside of the rear cover 5, and thus is covered by the rear cover 5 without exposure to the outside.

The details of the rotor 12 are now explained. As illustrated in FIG. 2, each of the front rotor member 12F and the rear rotor member 12R constituting the rotor 12 has the plural, more specifically, six rotor magnet claw poles 12b each having an L-shaped cross section in the radial direction and extending from the axial outer end of the axial portion 12a. The rotor magnet claw poles 12b extending from the front rotor member 12F and the rear rotor member 12R are disposed alternately in the circumferential direction. Thus, there are provided the twelve rotor magnet claw poles 12b in total. In other words, the rotor 12 in this embodiment has twelve magnet poles.

The front rotor member 12F and the rear rotor member 12R thus structured are fixed to the shaft 8 in such a condition that the ends of the shaft portions 12a of the front and rear rotor members 12F and 12R contact each other with the respective rotor magnet claw poles 12b positioned alternately in the circumferential direction, along with the presence of the field winding 14 provided between the front and rear rotor members 12F and 12R.

A front fan 13F and a rear fan 13R functioning as cooling fans are attached to the axial outside ends of the front rotor member 12F and the rear rotor member 12R, respectively, by welding or other methods. The front fan 13F and the rear fan 13R are disposed symmetric so that air can flow toward the center by rotation of the rotor 12.

Concerning the structure of the front fan 13F, for example, impellers having inclined surfaces with respect to the radial direction are formed integrally with the front fan 13F. These impellers are produced from plural projections provided on a metal plate in the circumferential direction and folded substantially in circular-act shapes and substantially in the vertical direction by press working in the circumferential direction. The front fan 13F and the rear fan 13R thus formed are fixed to the axial outer ends of the front rotor member 12F and the rear rotor member 12R and combined therewith by welding or other methods. Flow of air can be produced by rotation of the rotor thus constructed.

The airflow channels according to the example shown in FIG. 2 are now discussed. Air flows from an air inlet port 1a of the front bracket 1 to air outlet ports 1b of the front bracket 1 to cool the inside of the front bracket 1. On the other hand, air flows from the air inlet ports 5a of the rear cover 5 via an air inlet port 2a of the rear bracket 2 to air outlet ports 2b of the rear bracket 2 to cool the inside of the rear bracket 2. Particularly in the arrangement of the example shown in FIG. 2, the air inlet ports 5a formed in the rear cover 5 on the inner circumferential side thereof are located close to the brushes 11 and the rectification circuit 15, that is, in the vicinity of the shaft 8. Thus, the air directly cools these components. The example shown in FIG. 3 illustrates flow of air introduced through the outer-circumferential air inlet port 5a formed in the peripheral area of the rear cover 5 away from the shaft 8. As can be understood, the rear cover 5 has a number of air inlet ports 5a. The cooling air also flows between the front side and the rear side via the clearance between the rotor 12 and the stator 17 to cool the inside.

The details of the stator 17 are now explained. As illustrated in FIG. 2, the stator iron core 17a is a lamination of thin plates made of magnetic material in the shape of a coil. A plurality of slots (not shown) determined in correspondence with the number of the rotor magnet claw poles 12b are formed in the inner circumferential surface of the stator iron core 17a with a uniform pitch. The three-phase armature winding 17b wound in advance is inserted into the slots and connected therewith by Y-connection or Δ-connection. Insulating paper as an insulating member is inserted into slot openings to prevent exposure of the armature winding 17b provided within the slots toward the inner circumferential surface of the stator iron core 17a.

The stator 17 in this embodiment has twelve magnetic poles per one phase, i.e., the same number of magnetic poles as that of the rotor 12.

The surface of the armature winding 17b is covered with insulation coating such as varnish. The terminal of the armature winding 17b is extended through the rear bracket 2 and connected with a terminal 15a of the rectification circuit 15. Insulating paper as an insulating member may be provided between the stator iron core 17a and the armature winding 17b.

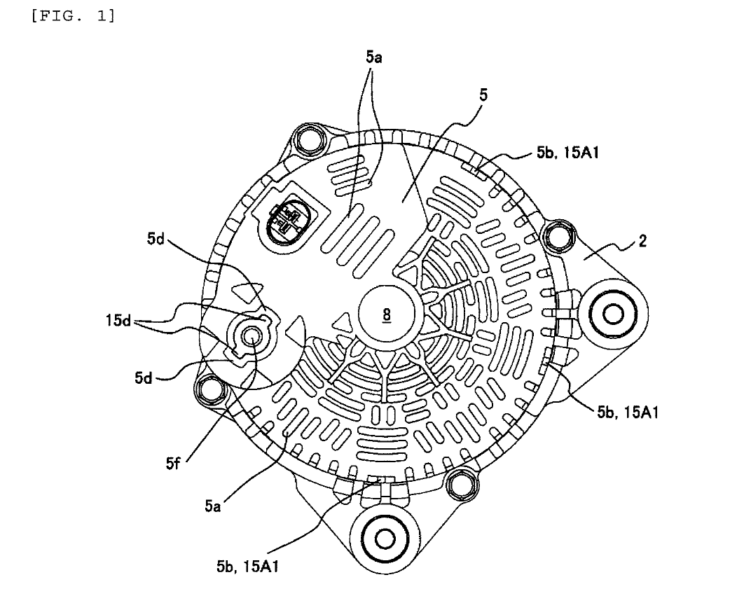

FIG. 1 illustrates the electrical rotating machine as viewed in the direction of an arrow A in FIG. 2. The substantially circular rear cover 5 has a number of air inlet ports 5a both on the inner circumferential side and the outer circumferential side around the shaft 8. The pattern produced by the air inlet ports 5a may vary according to the positions of the rectification circuit 15, the IC regulator, the slip rings 10, the brushes 11 and other components contained in the housing space within the rear bracket 2, for example.

The first devised point associated with attachment of the rear cover 5 to the electrical rotating machine is prevention of movement of the rear cover 5 in the axial direction by using engaging points formed at plural points of the side wall of the bottomed cylindrical shape of the rear cover 5 to engage with the rear bracket. Engaging openings formed at plural points of the circumference of the rear cover 5 are designated by a reference number 5b in FIG. 1. Engagement between the engaging openings 5b and engaging claws 15A1 formed on the rear bracket side fixes the rear cover 5 to the electrical rotating machine, thereby preventing movement of the rear cover 5 in the axial direction.

The method for allowing engagement between the engaging openings 5b formed at plural points of the circumference of the rear cover and the engaging claws 15A1 on the rear bracket side is now explained. There are various methods considered as engaging methods. For example, selection of the portion of the rear bracket to be engaged, the way of engagement, and determination of the claw side and the receiving side from the two sides may be arbitrarily designed. Discussed herein is one of the methods considered as the most appropriate methods.

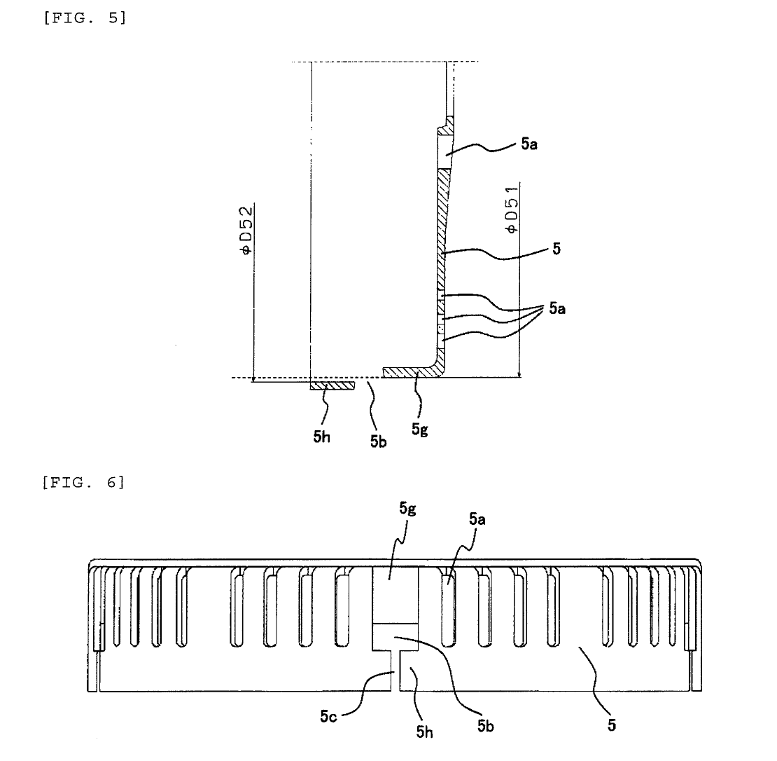

According to this embodiment, the rear cover 5 is initially produced in the manner illustrated in FIGS. 5 and 6. FIG. 5 is a cross-sectional view of the rear cover 5, while FIG. 6 is a side view of the rear cover 5. As apparent from these figures, the side wall and the bottom wall of the rear cover 5 have the plural air inlet ports 5a through which air flows. Moreover, the rear cover 5 has the plural engaging openings 5b on the same wall as the side wall where the air inlet ports are provided.

As illustrated in FIG. 5, each shape of the engaging openings 5b has a step produced by setting an outside diameter φD51 of the side wall of the rear cover 5 on the bottom wall side (right side in FIG. 5) smaller than an inside diameter φD52 of the side wall on the end opening side (left side in FIG. 5), i.e., φD51<φD52. Accordingly, an engaging portion 5g in FIG. 6 is located at a position shifted toward the inside from the position of an engaging portion 5h. This positional deviation between the engaging portion 5g and the engaging portion 5h further secures engagement of the engaging claws. The rear cover made of resin or aluminum alloy can be easily formed into this shape by using a mold having two divided parts.

A slit 5c formed in the engaging opening 5b as shown in FIG. 6 opens the opening of the rear cover end surface and facilitates attachment and detachment of the rear cover 5. Moreover, the position of the engaging openings 5b located in the side wall of the rear cover 5 can reduce the axial height of the rear cover 5 to the minimum. In this case, the volume of the rear cover 5 stacked for packing can be reduced to the minimum, whereby the loading number of the rear cover 5 increases. Accordingly, the transportation efficiency improves, while the transportation cost decreases.

Concerning this point, the axial width of the rear cover becomes larger in the structure disclosed in PTL 1, requiring a volume corresponding to the length of the engaging claw at the time of stack of the rear cover. In this case, the loading number for packing decreases, wherefore the transportation efficiency lowers. As a result, the transportation cost rises.

The devised point associated with engagement on the rear bracket side is now explained. As a component for fixation of the rear cover 5, the engaging claws 15A1 are provided for engagement between the rear cover 5 and a mold terminal 15A inserted for insulation between a positive electrode diode and a negative electrode diode provided on the rectification circuit 15.

The engaging claws 15A1 are provided on the mold terminal 15A because the mold terminal 15A as a component disposed along the outer circumference of the rear bracket 2 has a shape appropriate for engagement at plural engaging points with a fastening point corresponding to the position of a through hole 5f, and provides electric insulation between the electrical rotating machine and the rear cover 5 as an insulating member.

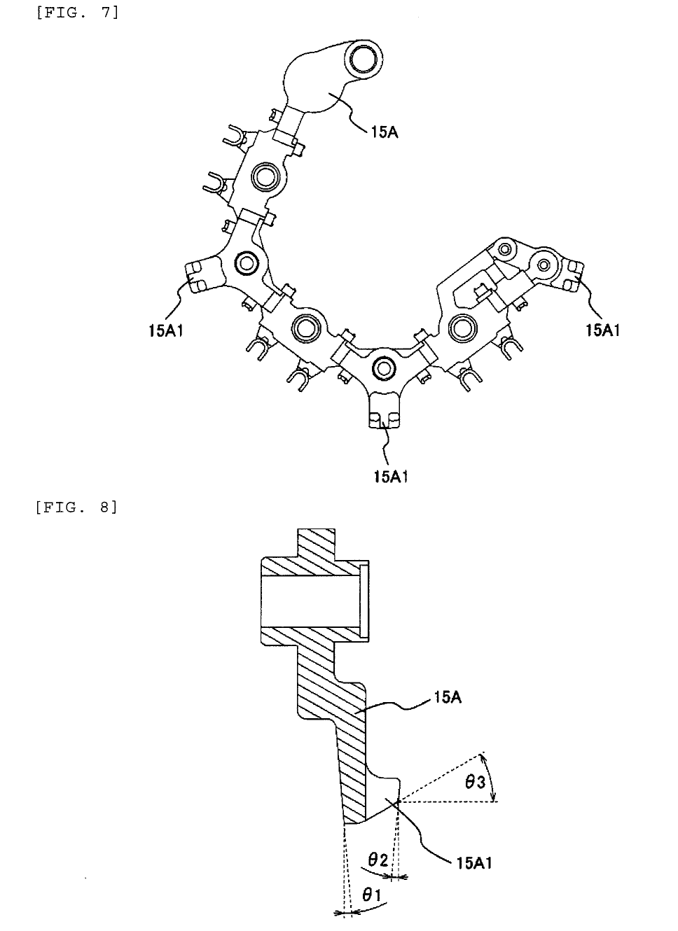

FIG. 7 illustrates an example of the mold terminal 15A. FIG. 8 is a cross-sectional view of the part of the engaging claw 15A1. According to the mold terminal 15A shown in FIG. 7, the engaging claws 15A1 are attached to at positions corresponding to the engaging openings 5b of the rear cover 5 shown in FIG. 1. As illustrated in FIG. 8, the surface of the engaging claw 15A1 in contact with the rear cover 5 has a gradient (081, 082) in the direction from the outer circumference to the inner circumference of the engaging claw 15A1.

According to this structure, the gradient of the engaging claw 15A1 can absorb the clearance in the axial direction produced at the time of attachment of the rear cover 5, thereby eliminating interference noise generated by movement of the rear cover 5 in the axial direction. This gradient may be given to the surface of the engaging opening 5b of the rear cover 5 in contact with the engaging claw 15A1. The axial outer circumferential surface of the engaging claw 15A1 has a gradient (0≦θ3) for facilitating attachment of the rear cover 5.

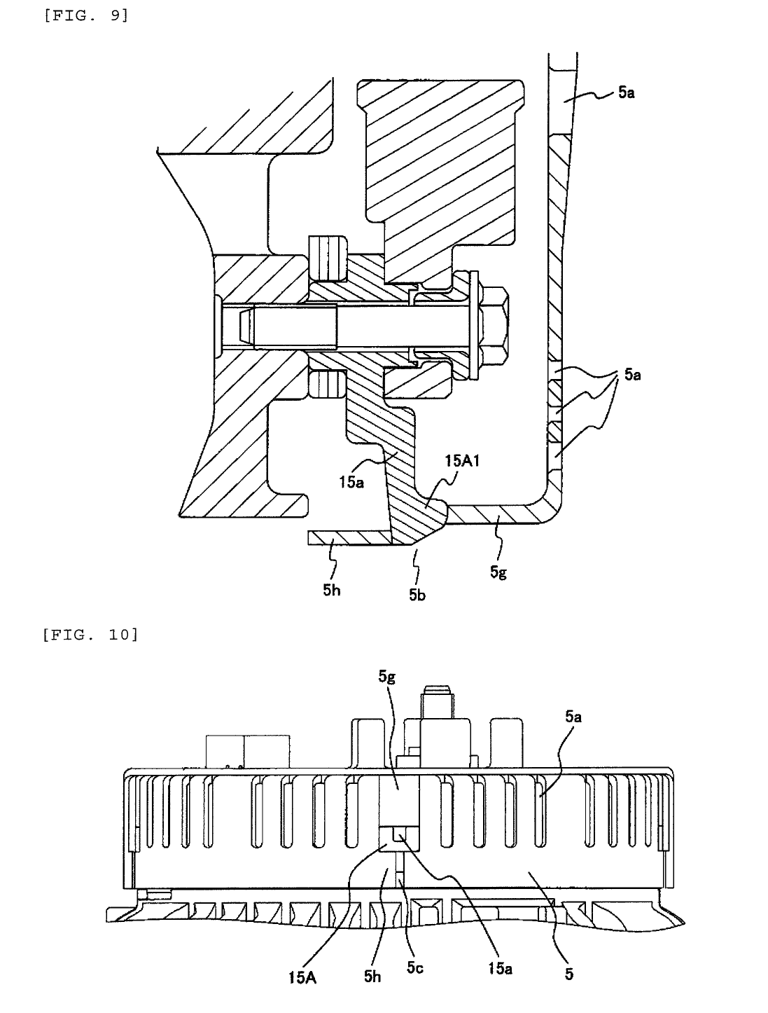

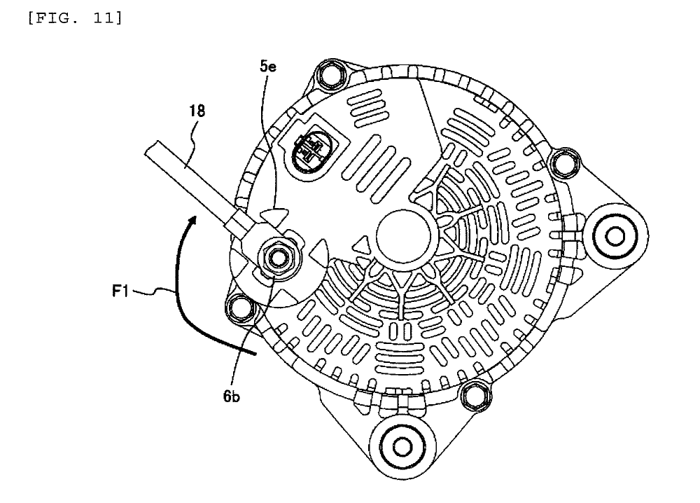

FIG. 9 is an enlarged view of the right lower part in FIG. 2. As apparent from the figure, the engaging claw 15A1 of the mold terminal 15A shown in FIG. 8 engages with the stepped space 5b produced by the side walls 5g and 5h of the rear cover 5 shown in FIG. 5. According to this embodiment, therefore, there are provided plural points engaging with the electrical rotating machine with the fastening point corresponding to the position of the through hole 5f of the rear cover 5. The rear cover 5 is fixed to the electrical rotating machine by engagement between the engaging openings 5b formed at plural points of the circumference of the rear cover 5 and the engaging claws 15A1 on the electrical rotating machine side. FIG. 10 illustrates the rear cover 5 under the engagement condition as viewed in the same direction as that of FIG. 6. As can be seen from the figure, the engaging claw 15A1 is sandwiched between the engaging portion 5g and the engaging portion 5h. The engaging claw 15A1 contacting the rear cover 5 has a concave shape, corresponding to an air inlet port 15a at the time of engagement with the rear cover 5.

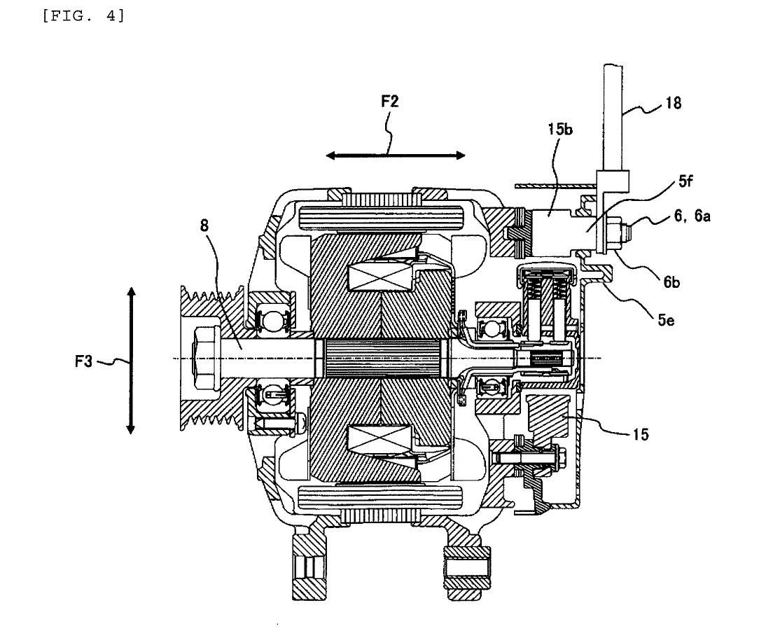

The second devised point associated with attachment of the rear cover 5 to the electrical rotating machine is the through hole 5f penetrating the bottom wall of the bottomed cylindrical rear cover 5 as an opening for receiving the output terminal 6 shown in FIG. 2 as a component connected with the outside battery. The relationship between the output terminal 6 and the through hole 5f is well expressed in FIG. 4. The output terminal 6 attached to a fin 15b of the positive electrode diode of the rectification circuit 15 has a screw 6a so that a vehicle side current supply harness 18 can be fixed to the output terminal 6 by a bolt 6b. In FIG. 1, locking convexes formed on the fin 15b of the positive electrode diode are designated by a reference number 15d, while locking concaves are designated by a reference number 5d. When the rear cover 5 is made of aluminum alloy, an insulation material for securing insulation is inserted between the rear cover and the fin 15b of the positive electrode diode. Alternatively, the fin 15b of the positive electrode diode may be coated with insulation material.

The importance of the second devised point lies in that the rear cover 5 is not fixed by the bolt 6b in this embodiment. According to this embodiment, the fin 15b of the positive electrode diode of the rectification circuit 15 having a diameter slightly smaller than the diameter of the through hole 5f of the rear cover 5 penetrates the through hole 5f so as to allow engagement between the rear cover 5 and the electrical rotating machine. The bolt 6b only fixes the vehicle side current supply harness 18. According to this structure, movement of the rear cover 5 in the circumferential direction caused by vibrations can be avoided.

Concerning this point, the structure disclosed in PTL 1 requires a spacer formed integrally with the bolt and the rear cover for fixation of the rear cover. This means that the structure requires equipment for fastening the bolt at the time of manufacture of the electrical rotating machine, and torque management at the time of the work for fastening the bolt. Accordingly, the manufacturing cost rises.

According to this embodiment, fixation allowed only by the first devised point can be achieved with higher rigidity when the second devised point is added.

The operation of the structure according to this embodiment described above is now explained. Initially, rotation generated in accordance with the start of the engine is transmitted from the crank shaft through the belt to the pulley 9 to rotate the rotor 12 via the shaft 8.

When direct current is supplied from the brushes 11 via the slip rings 10 to the field winding 14 provided on the rotor 12, magnetic flux circulating around the inside and outside circumferences of the field winding 14 develops. As a result, the N-poles or the S-poles are alternately formed on the rotor magnet claw poles 12b of the rotor 12 in the circumferential direction. The magnetic flux produced by the field winding 14 circulates in the direction from the rotor magnet claw N-poles 12b of the front rotor member 12F toward the armature winding 17b of the stator 17.

The magnetic flux then reaches the rotor claw magnetic S-poles 12b of the rear rotor member 12R to form a magnetic circuit circulating the rotor 12 and the stator 17. The magnetic flux generated by the rotor inverwines with the armature winding 17b in this way, whereby alternating current inductive voltage develops in the armature winding 17b for each of the U-phase, V-phase, and W-phase. As a result, three-phase alternating current inductive voltage develops as a whole.

The alternating current voltage thus generated is rectified by the rectification circuit 15 for full wave rectification to be converted into direct current voltage. The rectified direct current voltage is adjusted to a constant voltage of approximately 14.3V by the control over the current supplied to the field winding 14 using the function of the IC regulator (not shown).

When the rotor 12 rotates, the front fan 13F and the rear fan 13R also rotate in accordance with the rotation of the rotor 12. As a result, flow of air which introduces the outside air in the axial direction corresponding to the inside circumferential side and discharges the air in the outer circumferential direction is produced as indicated by arrows with broken lines in FIG. 2.

The rear cover 5 is attached in such a manner as to cover the rectification circuit 15 and the IC regulator for protection thereof. Fixation of the rear cover 5 is achieved by engagement between the plural engaging claws 15A provided on the mold terminal 15A sandwiched for insulation between the positive electrode diode and the negative electrode diode of the rectification circuit and the engaging openings 5b formed in the side wall of the rear cover 5.

The front fan 13F rotates to introduce the outside air in the axial direction through the air inlet port 1a of the front bracket 1 formed in the outside circumferential portion of the ball bearing 7a. The introduced air is rectified in directions as indicated by the arrows with broken lines in FIG. 2 at the time of flow toward the outside circumference by the centrifugal force generated by the impellers of the front fan 13F. Then, the air is discharged through a plurality of air outlet ports 1d formed in the outer circumferential portion of the front bracket 1 in the circumferential direction.

The one axial side surface and the outside circumferential surface of the stator 17 are fixed to the front bracket 1 in contact therewith. Thus, heat generated by the stator 17 is transmitted to the front bracket 1 and released from the surface of the front bracket 1. The heat released from the front bracket 1 is discharged to the outside along with the air flowing toward the air outlet ports 1b, achieving cooling the armature winding 17b of the stator 17.

The rear fan 12R rotates to introduce the outside air in the axial direction from the air inlet ports 5a formed in the outer circumferential side periphery of the rear cover 5 and the air inlet ports 15a produced by the engaging openings 5b formed in the side wall of the rear cover 5 and the concave engaging claws 15A1 provided on the mold terminal 15A, such that the air can pass along the rectification circuit 15 and through the air inlet port 2a formed in the outside circumferential portion of the ball bearing 7b of the rear bracket 2.

The introduced air is rectified in directions indicated by the arrows with broken lines in FIGS. 2 and 3 at the time of flow toward the outside circumferential side by the centrifugal force generated by the impellers of the rear fan 12R, and discharged through a plurality of the air outlet ports 2d formed in the outer circumferential portion of the rear bracket 2 in the circumferential direction. Thus, similarly to the front bracket 1, the heat generated from the stator 17 and the heat of the stator 17 transmitted to the rear bracket 2 are both released through the surface of the rear bracket 2, and cooled by the air flowing toward the air outlet ports 2b.

Moreover, air flows through the clearance between the magnetic poles of the rotor 12 and the clearance between the rotor 12 and the stator 17 by the pressure difference between the pressure of the front fan 13F and the pressure of the rear fan 13R produced by the rotation. According to this embodiment, the pressure produced in the rear fan 13R becomes larger. Thus, air flows from the front bracket 1 through the clearance between the rotor 12 and the stator 17 and between the magnetic poles of the rotor 12 toward the rear bracket to cool the rotor 12 and the stator 17.

At the time of attachment of the output terminal harness to the alternating current generator for vehicle from the vehicle side, a force in the circumferential direction acts on the rear cover. This circumferential force is resisted by a locking mechanism constituted by the concaves 5d of the rear cover, and the convexes 15b of the fin of the positive electrode diode, both forming the output terminal shape of the alternating current generator for vehicle as illustrated in FIG. 1.

The reasons that the engagement structure according to this embodiment is appropriate particularly for the electrical rotating machine mounted on a vehicle are now discussed in detail.

An electrical rotating machine mounted on a vehicle such as an alternating current generator is attached directly to an engine. In this case, vibrations generated by the engine are transmitted to the alternating current generator. Moreover, the generator itself also vibrates by a magnetic exciting force generated by rotation of the rotor. The directions of the vibrations generated on the generator are indefinite. Furthermore, the running vehicle generates a number of vibrations. These vibrations are a combination of vibrations such as radial vibration F3 toward the circumference from the shaft 8 shown in FIG. 4 and axial vibration F2 in the direction of the shaft 8. Thus, the force for fixing the rear cover 5 of the alternating current generator requires a sufficient strength for enduring vibrations in indefinite directions generated on the alternating current generator.

Moreover, the rear cover 5 needs to secure a sufficient strength for resisting circumferential force F1 generated at the time of fixation of the vehicle side current supply harness 18 shown in FIG. 11 in addition to the vibrations discussed above. Concerning this point, the generator has the output terminal 6 for supplying electric current generated by the generator to the vehicle.

As apparent from the structure of the output terminal 6 shown in FIG. 4, the bolt 6a is attached to the fin 15b of the positive electrode diode, and the bolt 6 has the screw 6a. On the other hand, the current supply harness 18 is provided on the vehicle side to which electric current is supplied. The current supply harness 18 is fixed to the output terminal 6 by fastening the screw 6a of the bolt and the nut 6b. At the time of fixation of the current supply harness 18 via the nut 6b, a projection 5e provided on the rear cover 5 functions as a lock for the current supply harness 18. In this case, the circumferential force F1 generated at the time of fastening of the nut 6b acts on the rear cover 5.

The method for fixing the rear cover disclosed in PTL 1 employs a structure which allows engagement between a hook provided on an engaging claw of the rear cover and the generator main body. For attachment of the rear cover, the hook of the engaging claw needs to be bended by the amount of the thickness of the hook while elastically deforming the engaging claw. Thus, there is a limitation to the thickness of the engaging claw, wherefore a sufficient strength cannot be secured for enduring the vibrations generated on the generator.

Moreover, according to the structure which fixes the rear cover engaging claw and the generator main body at one point (contact portion), the rear cover engaging claw separates from the generator main body at the time of generation of the axial vibration F2, thereby producing interference noise.

Furthermore, concerning the circumferential force F1 generated at the time of fixation of the current supply harness, the rear cover and the generator main body are fixed to each other via a bolt and a nut.

According to this embodiment, however, the rear cover is fixed only by the engaging portion without using a bolt and a nut, that is, by engagement between the engaging claws 15A1 provided on the main body side and the engaging openings 5b formed in the rear cover 5.

According to PTL 1, the fixing point (contact portion) between the rear cover engaging claw and the generator main body is only one point. In this case, the structure does not resist vibrations in indefinite directions. According to this embodiment, however, the fixing point (contact portion) of the engaging claws regulates four directions (upward, downward, leftward, and rightward). Moreover, the plural engaging portions disposed in the circumferential direction can resist vibrations of the axial vibration F2, the radial force F1 and other indefinite direction forces generated on the generator. Thus, the rear cover and the generator main body do not separate from each other, and thus produce no interference noise.

At the time of attachment of the vehicle side current supply harness 18 to the output terminal 6 of the generator, the vehicle side current supply harness 18 is attached by using the locking projection 5e of the rear cover. In this case, the circumferential force F1 acts on the output terminal 6 of the rear cover. For resisting the circumferential force F1, concave and convex shapes are employed for the shapes of the fin 15b of the positive electrode diode constituting the output terminal 6 of the generator and the hole of the rear cover.

Moreover, the slight press fit of the output terminal 6 of the generator and the fin 15b of the positive electrode diode constituting the output terminal 6 into the through hole of the rear cover raises the force for fixing the rear cover greater than the fixing force produced only by engagement of the engaging claw.

The engaging claws provided on the generator main body do not require elastic deformation of the claws. Thus, there is no limitation to the thickness of the engaging claws, allowing determination of a sufficient thickness of the engaging claws for securing the necessary strength.

When the engaging claws provided on the generator main body are made of resin material (insulating material), the engaging claws have the same potential as that of the rear cover. This structure can prevent electric shocks resulting from contact with the outside.

While the alternating current generator has been discussed as an example of the electrical rotating machine in the foregoing explanation of this embodiment, the electrical rotating machine may be other types of machines such as a motor and a direct current machine. In this case, the output terminal extended to the outside through the rear cover 5 corresponds to a terminal for power supply. Therefore, this power terminal is generally used for fastening the rear cover 5.

### REFERENCE SIGNS LIST

1: front bracket, 2: rear bracket, 1a, 2a, 5a, 15a: air inlet port, 1b, 2b: air outlet port, 5: rear cover, 5b: engaging opening, 5c: slit, 5d: locking concave, 5e: locking projection for vehicle side current supply harness, 6: output terminal, 6a: screw, 6b: bolt, φD51: outside diameter of side wall on rear cover bottom wall side, φD52: inside diameter of side wall on rear cover opening side, 12: rotor, 13F: front fan, 13R: rear fan, 15: rectification circuit, 15A: mold terminal, 15A1: engaging claw, 15b: fin of positive electrode diode, θ1, θ2, θ3: gradient of engaging claw, 15b: locking convex of fin provided on positive electrode diode, 17: stator, 17a: stator iron core, 17b: armature winding, 18: vehicle side current supply harness, F1: circumferential force, F2: axial vibration, F3: radial vibration

1. An electrical rotating machine, comprising:
a rotor;
a stator provided with an armature winding, the rotor and the stator being housed in a housing space formed by a front bracket and a rear bracket; and
a rear cover provided with a circumferential side wall and a bottom wall and disposed near the bottom of the rear bracket,
wherein
the rear cover includes a plurality of engaging openings formed in the circumferential side wall of the rear cover, and steps of the engaging openings each produced by the difference between the diameter of the side wall on the bottom wall side and the diameter of the side wall on the end opening side, and
the bracket has engaging portions inserted into the corresponding steps for fixing the rear bracket.

2. The electrical rotating machine according to claim 1, wherein the diameter of the side wall on the bottom wall side is smaller than the diameter of the side wall on the end opening side.

3. The electrical rotating machine according to claim 1, further comprising slits between the engaging openings on the end opening side and the end opening.

4. The electrical rotating machine according to claim 1, wherein the engaging openings are disposed on the inner side with respect to the side wall axial length of the rear cover.

5. The electrical rotating machine according to claim 1, wherein each of the engaging surfaces of the engaging openings has a gradient in the direction from the outside circumference to the inside circumference.

6. The electrical rotating machine according to claim 1, wherein the plural engaging portions engaging with the openings of the rear cover and fixed to the rear bracket are engaging claws, the engaging claws being either engaging claws provided on a component contained in the rotating generator covered by the rear cover or engaging claws provided on the rear bracket.

7. The electrical rotating machine according to claim 1, wherein each of the engaging portions fixed to the rear bracket has a surface engaging with the rear cover and having a gradient in the direction from the outside circumference to the inside circumference.

8. The electrical rotating machine according to claim 1, wherein each of the engaging portions fixed to the rear bracket has a surface engaging with the rear cover and having a concaved shape.

9. (canceled)

10. The electrical rotating machine according to claim 9, further comprising engaging portions disposed on a mold terminal for insulation sandwiched between a positive electrode diode and a negative electrode diode of a rectification circuit, wherein the engaging portions engages with a plurality of engaging openings of the rear cover.
